(19) United States
(12) Patent Application Publication
(10) Pub. No.: US 2024/0223663 A1
(43) Pub. Date: Jul. 4, 2024

(54) SYSTEMS AND METHODS FOR REMOTELY CONTROLLING MOBILE DEVICE OPERATIONS

(71) Applicant: Hamid Boulares, River Ridge, LA (US)

(72) Inventor: Hamid Boulares, River Ridge, LA (US)

(21) Appl. No.: 18/402,515

(22) Filed: Jan. 2, 2024

Related U.S. Application Data
(60) Provisional application No. 63/436,678, filed on Jan. 2, 2023.

(51) Int. Cl. H04L 67/125; H04L 67/52

(52) U.S. Cl. CPC H04L 67/125; H04L 67/52

(57) ABSTRACT

A system is described herein comprising a remote application and an operating system application, the operating system application receiving a notification from the remote application, wherein the notification comprises one or more access permission options for allowing access by the remote application to operations of the mobile device through installation of one or more applications, the operating system installing the one or more applications according to a selection of one or more access permission options, a monitoring application running on a processor of a hardware device, wherein the monitoring application transmits a monitoring signal throughout at least a portion of a premises, the one or more applications detecting the monitoring signal, and the one or more applications transmitting a location notification to the remote application and receiving instructions from the remote application in response to the detection of the monitoring signal.

### RELATED APPLICATION

This application claims the benefit of U.S. Application No. 63/436,678, filed Jan. 2, 2023.

### TECHNICAL FIELD

Embodiments are described herein relating to remotely controlling operations of a mobile device.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE FIGURES

FIG. 1 shows a hardware application communicatively coupled with applications running on processors of multiple respective devices located in a target environment, under an embodiment.

FIG. 2 shows a hardware application communicatively coupled with administrative applications running on one or more processors of a remote server, under an embodiment.

FIG. 2 shows a network architecture for controlling mobile devices, under an embodiment.

FIG. 3 shows a network architecture for controlling mobile devices, under an embodiment.

FIG. 4A shows a network architecture for controlling mobile devices, under an embodiment.

FIG. 4B shows a network architecture for controlling mobile devices, under an embodiment.

FIG. 5 shows a network architecture for controlling mobile devices, under an embodiment.

FIG. 6 shows a network architecture for controlling mobile devices, under an embodiment.

### DETAILED DESCRIPTION

Heavily attended events (e.g., conferences, concerts, sporting events, etc.) means that many users collect in one place and bring their mobile devices with them. Applications on a mobile device may cause distractions. Passenger carriers confront analogous issues. For example, a large number of passengers may travel together in a large carrier airplane. Again, passengers board the aircraft with mobile devices. Normal operation of the device may distract other passengers and/or interfere with third party communications. Passengers are often asked to activate airplane mode. However, the carrier generally relies upon each user for compliance.

The embodiments described herein are directed to systems and methods for at least partially controlling operations of mobile devices in communal settings. Under an embodiment, a hardware device is placed in a communal space setting to enable communications with and control certain operations of mobile devices entering and residing within an environment.

Implementation of this system and method may occur in a small target environment, e.g. a relatively small conference room environment. Under an embodiment, the target environment may comprise a large event setting, i.e. a large conference room with many attendees. Operation of the system and method within a large conference setting is described below for illustrative purposes.

A hardware device is located in a large conference setting, under an embodiment. One or more applications (referred to herein as a hardware application or application) run on one or more processors of the hardware device. The application transmits RF signals within the environment (or alternatively mechanical signals as described below). When a user with a mobile device enters the environment, a mobile device application (herein referred to as an App) detects the RF signal and reads the information provided by (or modulated onto) the RF signal.

Under an embodiment, a user may download the App prior to attending the conference. Under an alternative embodiment, event organizers may provide a publicly displayed QR code. Mobile devices may then interact with the QR code for download of the App. Under yet another embodiment, the hardware application may transmit instructions to the mobile device operating system for downloading the App. In differing environments, e.g. a passenger carrier space, a QR code may be provided on boarding passes. Under the above referenced scenarios, the App may be available through Apple, Android, or other third party application portals.

Under one embodiment, the App may be mandatory. Alternatively, the App may provide the user with opt in/opt out feature. Conference organizers (hereinafter collectively referred to as administrator) may configure the application for either option. When the App is running on the mobile device, the App may detect the hardware application and present a user with a choice of opting in to conference mobile device settings. A user may opt out of these settings. Under an alternative, opt in may be required. In other words, the user may be allowed to opt out but may then be denied entry to the event. For example, the application may itself provide a visual “ticket” to the event after the user activates the opt in feature. Otherwise, the user attendee may be denied entry. In that scenario the App is itself required for entry to an event and opt in may in fact be part of the App's terms and conditions. (Note that installation of the App may be required as part of a ticketing process. For example, an airline ticket purchasing system may require evidence of the App's installation on a user device. As part of the purchasing process, the purchasing system may authenticate the user's mobile device through the App (or using information provided to the user through the App).

The hardware device either continuously or intermittently broadcasts RF signals. The enabled App detects and interacts with the hardware application to provide a communicative coupling. In other words, the App detects the RF signal and establishes communications with the hardware application. Communication paths couple the system components (i.e. the hardware application and the App) and include any medium for communicating or transferring files/data among the components. The communication paths may include cellular networks, couplings or connections to networks including local area networks (LANs), metropolitan area networks (MANs), wide area networks (WANs), wireless personal area networks (PAN), proprietary networks, interoffice or backend networks, and the Internet.

Note that the initial broadcast or triggering signal may be a transmission other than an RF signal. For example, the hardware may transmit a mechanically generated signal. Such signal may or may not be controlled by or originate from the hardware application. Under an embodiment, a mechanical signal (e.g., an acoustic signal) is continuously transmitted within the target environment. When the App detects the mechanical signal, e.g. through a mobile device peripheral, the App may then establish an independent communications coupling with the hardware application.

Hardware devices may be distributed throughout the conference premises. With respect to large target environments, this may be required to ensure an App's detection of RF and/or mechanical signals throughout the monitored premises.

Under an embodiment, the App may detect an RF signal controlled by the hardware application and emitted by hardware device transmitter(s). The hardware application may be communicatively coupled to a conference wide WiFi network using multiple access points, repeaters, and other devices required to generate WiFi coverage throughout the conference premises. Under this embodiment, a hardware application running on a processor of a single networked hardware device may control transmission of the RF signal throughout the premises. Under this embodiment, the hardware device (or devices) may comprise a computing device (or other processor based device) running one or more applications using one or more receivers or transceivers communicating with mobile devices directly or through networked communicative couplings.

The hardware application may communicate with a remote server which runs one or more administrative applications. The server may provide administrative applications to remote devices for use by an administrator user of the system. The administrator may use the administrative applications to configure the hardware application according to the requirements of the conference setting and transmit corresponding instruction sets to the mobile device App. The administrator may remotely establish a set of operational permissions. The set of permissions establishes operational use of the mobile device within the target environment. For example, a conference may require that all phones operate on silent mode. Under an alternative, a conference may require that all mobile devices operate in airplane mode. However, airplane mode may shut down wireless communications. In this event, the hardware application may instruct the App (or user attendee via mobile device user interface) to maintain, initiate, and/or reinitiate Bluetooth and/or wireless communications. The App may then maintain a communications coupling with the hardware application. Accordingly, the hardware application may still provide instructions to the App when airplane mode is enabled.

As indicated above, the hardware application may transmit instruction sets to the mobile device App for establishing a set of operational permissions. The hardware application may be preconfigured to transmit certain instruction sets based on requirements of a venue. Alternatively, the administrative applications may remotely configure instruction sets for transmission by the hardware application. Under yet another embodiment, administrative applications may transmit (and intermittently update or reconfigure) instruction sets directly to the App.

Note that the configuration of the hardware application depends on the environment. If the system is deployed in an environment with strict security protocols, the App may completely shut down (or require powering down) of mobile devices. A mobile device that is then powered back up without authorization may alert the system. In other words, the App may be configured as a start-up App that reports powering up to the system.

A mechanically generated signal may or may not be audible. Under an embodiment, the mobile device App includes a sound detection application module which monitors the environment for certain frequencies which may comprise high or low frequencies inaudible to human hearing. Once installed on a user attendee's mobile device, the App may then monitor and detect mechanical signals comprising a single frequency or multiple frequencies. Under an embodiment, an App may detect single and/or multiple frequencies within a range.

Upon establishing a communications coupling, the hardware application at least partially controls the mobile device through communication with the App. Under an embodiment, the App continuously runs on the mobile device while the attendee user is within the target environment. When a user attendee leaves the conference, the App may lose contact with hardware application communications. For example, the device may exit a range of Bluetooth or WiFi communications. When the App loses such connection, the App may then return the device to normal operations and notify a user of this fact. Similarly, the App may monitor alternative signals (e.g. a mechanically generated signal) through a peripheral and return the device to normal operations when the device exits the range of such signal.

Under an embodiment, the App may run continuously in the background of the mobile device operating system throughout the duration of an event. Under this embodiment, the hardware application (or administrative applications) may be configured to transmit a permissions set which is time delimited. For example, the App may implement a set of access controls during “working hours” from a first day to a last day. Note that “working hours” simply refers to a daily time span, e.g. 9 am-5 pm, and may apply to weekend days. The App then implements permissions or access control during the given time frame using the methods already described above.

Under one embodiment, the mobile device App may request authentication information from a user attendee. As just one example, the App may require user attendee input of a conference identification number. Under an alternative, the user attendee may simply input name or other identifying information previously provided by the user during a registration process that is independent of the App.

Under an embodiment, the hardware application and the mobile device App are wirelessly communicatively coupled. The RF signals may be encrypted, under an embodiment.

The systems and methods described herein may be available to event organizers on a subscription basis. Under an embodiment, the system may be offered to event organizers as a SaaS model, wherein the SaaS applications are communicatively coupled with an on premises hardware device (running an application) through network connectivity.

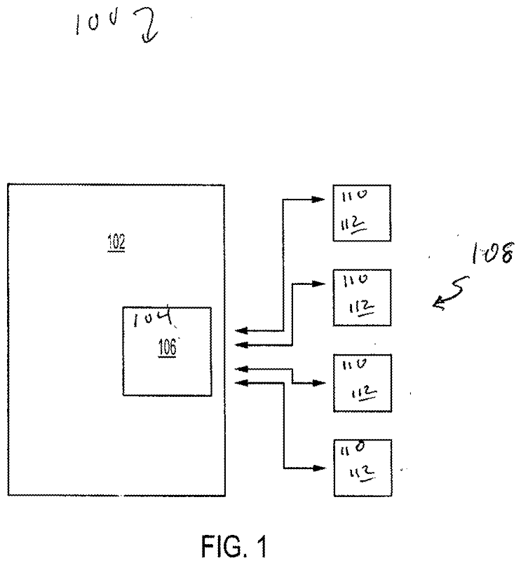

FIG. 1 shows a hardware application 104 running on one or more processors 106 of a hardware device 102 in a target environment 100. The hardware application is communicatively coupled with applications 110 running on respective processors 112 of multiple mobile devices 108 located in the target environment 100, under an embodiment.

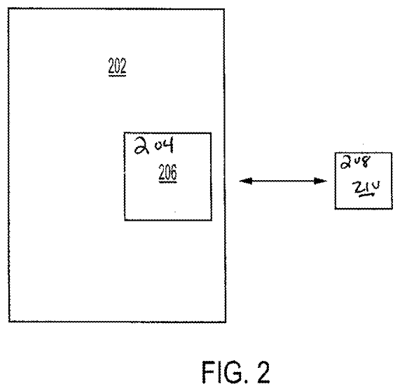

FIG. 2 shows a hardware application 204 running on one or more processors 206 of a hardware device 202 located in a target environment 200. The hardware application is communicatively coupled with at least one administrative application 208 running on at least one processor 210 of a remote server, under an embodiment.

Under an embodiment, no on-premises hardware device is required. This is due to the fact that users may simply download the App on their respective devices according to the requirements of event organizers (or rather administrators). Users opt-in wholly or at least partially to cede temporary access to local device operations to the extent necessary for administrator to monitor/control device operations during events. In short, the administrator may perform all of the above-described monitoring and/or control operations through networked commination couplings with the mobile devices without the need for a dedicated on-premises hardware device. Under this embodiment, an administrator may track a location of the device and implement restrictions when the device is within a given area.

Under either embodiment referenced above, i.e. dedicated hardware device coupled to a network or simply networked based communicate couplings, the following networks are described for use in the systems and methods for controlling mobile device operations.

Devices are connected to a network using one or more protocols. Several types of networks allow the connection of the Devices to the server (control equipment) which makes it possible to activate and deactivate functionalities on the devices such as camera, microphone, etc.

Potential networks include WiFi networks, Internet networks, Cellular networks (2G, 3G, 4G, 5G), bluetooth networks, IoT networks, LoRa, and Sigfox. The protocols in use for transmitting and receiving information include TCP/IP, ZigBee, LoRa, LPWAN, or any other standards-based protocol including IEEE 802.15.4, IEEE 802.11 and its variants, and IEEE 802 in general.

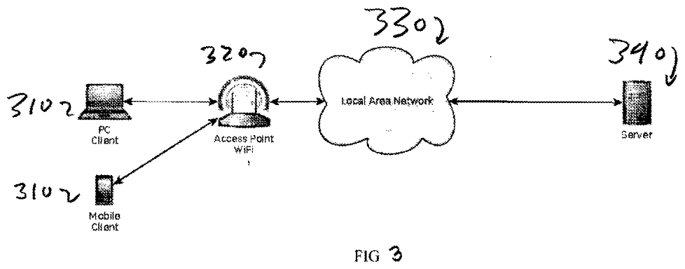

FIG. 3 features a system and method for controlling mobile device operations using a Wi-Fi network. Mobile devices may be controlled by connecting them to the host organization's “local WiFi network”. In the same local network, control solutions are launched using remote server software+hardware to connect all the devices with application.

Control solutions may activate and deactivate device features, e.g. camera, microphone, airplane mode, overall power, etc. FIG. 3 shows client devices 310 communicatively coupled to a local area network 330 through an access point 320. The devices are then coupled to a remote server 340 running one or more applications used by an administrator to monitor/control on-premises mobile devices.

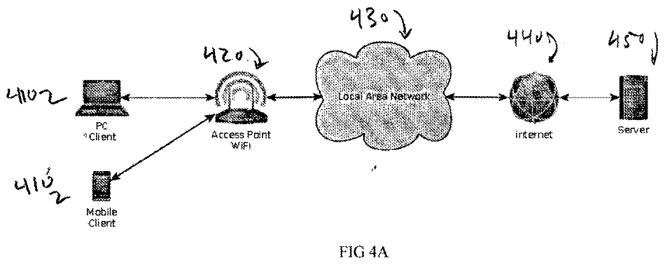

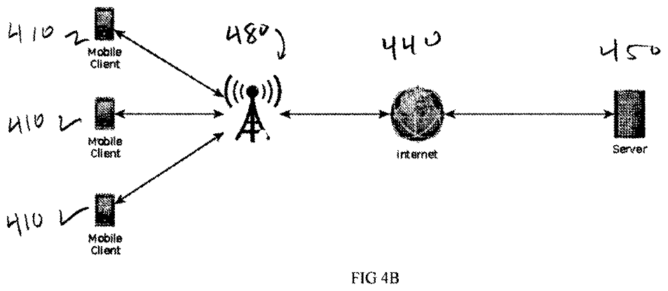

FIGS. 4A and 4B feature a system and method for controlling mobile device operations using an internet network (wifi and/or cellular). Under this embodiment, control solutions (server software+hardware) may be installed or hosted on any site through any internet connection. Control solutions may activate and deactivate device features, e.g. camera, microphone, airplane mode, overall power, etc.

FIG. 4A shows client devices 410 communicatively coupled to a local area network 430 through an access point 420. The devices are then coupled via general internet connectivity 440 to a remote server 450 running one or more applications used by an administrator to monitor/control on-premises mobile devices.

FIG. 4B shows client devices 410 communicatively coupled to the broader internet 440 through cellular connectivity 480. The devices are then coupled via cellular (2G, 3G, 4G, 5G) to a remote server 450 running one or more applications used by an administrator to monitor/control on-premises mobile devices.

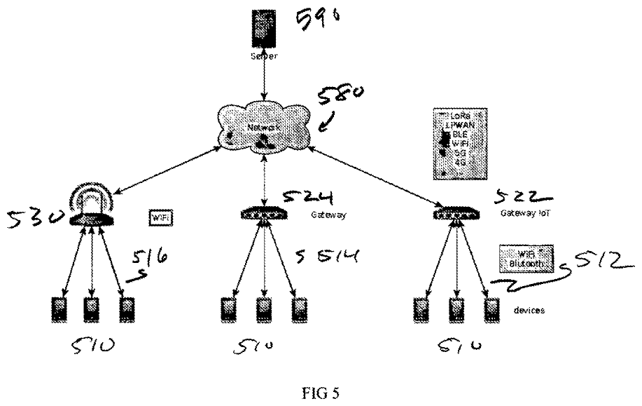

FIG. 5 shows a communications coupling to a proprietary network. One may control devices by connecting them to a proprietary network through gateways. These gateways are proprietary equipment that allow devices to connect using different technologies, for example switching from a Bluetooth network to a WiFi network, or switching from a WiFi network to an IoT network, etc. In this case the control solution (server software+hardware) can be installed or hosted on any site through any technology using any protocol and the user equipment uses any available technology.

FIG. 5 shows mobile devices 510 coupled through one or more networks 512, 514, 516 to a proprietary network 580 and ultimately to a server 590 hosting control solution applications. Note that networks 512 and 514 connect to gateways 522 and 524. As indicated above, these gateways are proprietary equipment that allow use of different networking technologies. A network gateway is a device or node that connects disparate networks by translating communications from one protocol to another. Therefore, networks 514, 516 may comprise WiFi, Bluetooth, LoRa, LPWAN, BLE, cellular, etc. Note that FIG. 5 also shows mobile devices 510 coupled through WiFi 530 to the proprietary network 580.

A system and method for controlling mobile devices may implement control by connecting devices to a mobile operator network. In this case, a control solution (server software+hardware) may be hosted in the AS “application server” of the mobile operators.

The control solution may activate and deactivate functionalities or option as (camera, microphone, etc.) or even put user equipment in airplane mode or turn them off through the network provided that the users are registered and authenticated in the network of the operator, i.e. the users are customers of the mobile operator.

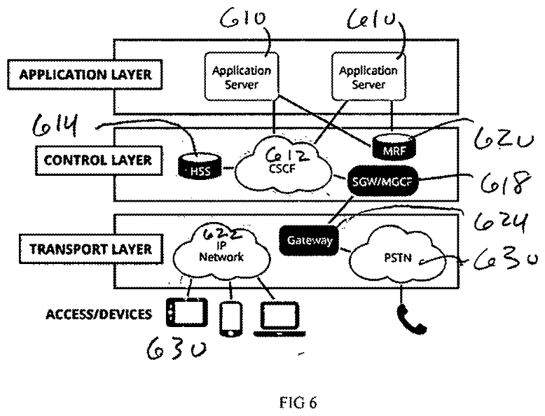

An IMS architecture (as shown in FIG. 6) enables secure and reliable multimedia communications between diverse devices across diverse networks. The architectural model provides a unified infrastructure and common mechanisms for controlling, manipulating, routing, and managing sessions. It also specifies how to implement authentication, authorization, and accounting controls. The IMS specifications incorporate widely used Internet Engineering Task Force (IETF) recommendations such as the Session Initiation Protocol (SIP) for session control signaling.

An application layer features applications servers 610 for controlling dedicated applications. The control layer (612, 614, 618, 620), often referred to as the IMS core, is the cornerstone of the architecture responsible for regulating communications flows. The main functional elements of the control layer include:
Application Servers—these are applications providing services, such as telephone call control, call continuity, conference calling, and supplementary service configuration
Call Session Control Function (CSCF) (612)—the heart of the IMS architecture, responsible for controlling sessions between endpoints (referred to as terminals in the IMS specifications) and applications
Home Subscriber Server (HSS) (614)—the master database that maintains all user profile information used to authenticate and authorize subscribers
Signaling Gateway (SGW) and Media Gateway Control Function (MGCF) (618)—respectively provide SS7 and MGCP interoperability with the PSTN
Media Resource Functions (MRF) (620)—provides media-related functions such as the playing of tones and digital announcements

Many IMS functions are further deconstructed into distinct functional elements. For example, the CSCF function encompasses three discrete roles: Serving-CSCF (C-CSCF), Interrogating-CSCF (I-CSCF), and Proxy-CSCF (P-CSCF).

A transport layer features IP Networks 622 connected to mobile devices 630. The transport layer may also feature gateways 624 connected to PSTN networks 630.

In this environment the control solution can be developed based on openAPI or other to be compatible with the IMS (Ip Multimedia Subsystem) standard of mobile operators.

A system and method for controlling mobile devices may implement control through SMS. In this case the control solution (server software+hardware) can be installed or hosted on any site with or without an internet connection.

The control solution will send SMS to the user equipment, the application at the user equipment level will interpret the SMS by converting them into control code to activate and deactivate functionalities (camera, microphone, etc.) or even turn on the airplane mode or turn the devices off.

Under an embodiment, the systems and methods described herein may be used to prevent exam takers from using mobile devices to access the internet during an exam. Under this embodiment, the systems and methods described herein may be used to disable mobile device communications or power mobile devices down when test takers and corresponding mobile devices are within a test taking environment.

Under an embodiment, the systems and methods described herein may be used to track, control, prohibit, and/or govern operations, motions, and controls of automated devices. Such automated devices may themselves be controlled at least in part by artificial intelligence systems.

A system comprising under an embodiment a remote application running on one or more processors of a remote server, an operating system application running on at least one processor of a mobile device, the operating system application receiving a notification from the remote application, wherein the notification comprises one or more access permission options for allowing access by the remote application to operations of the mobile device through installation of one or more applications, wherein the operating system application and the remote application are communicatively coupled through a network, the operating system installing the one or more applications according to a selection of one or more access permission options, a monitoring application running on a processor of a hardware device, wherein the monitoring application transmits a monitoring signal throughout at least a portion of a premises, wherein the one or more applications, the remote application, and the monitoring application are communicatively coupled through the network, the one or more applications detecting the monitoring signal, the one or more applications transmitting a location notification to the remote application through the network in response to the detection of the monitoring signal, the remote application transmitting one or more instructions to the one or more applications through the network upon receipt of the location notification, wherein the one or more instructions correspond to the one or more access permission options.

In embodiments, the monitoring application communicatively coupling with one or more additional monitoring applications running on processors of one or more additional hardware devices.

In embodiments, the one or more additional monitoring applications transmitting the signal through at least an additional portion of the premises.

In embodiments, the monitoring signal comprises an RF signal.

In embodiments, the strength of the RF signal defines a boundary region.

In embodiments, the one or more applications detecting the monitoring signal comprises the mobile device entering the boundary region.

In embodiments, the one or more applications losing the monitoring signal comprises the mobile device exiting the boundary region.

In embodiments, the one or more instructions comprise instructing the mobile device to enter airplane mode.

In embodiments, the one or more instructions comprise instructing the mobile device to disable camera operations.

In embodiments, the one or more instructions comprise instructing the mobile device to disable notifications.

In embodiments, the one or more instructions comprise instructing the mobile device to power down.

In embodiments, the network comprises a Local Area Networks (LAN).

In embodiments, the network comprises a Personal Area Networks (PAN).

In embodiments, the network comprises a metropolitan area network (MAN).

In embodiments, the network comprises a wide area network (WAN).

In embodiments, the network comprises interoffice or backend networks.

In embodiments, the network comprises cellular networks.

In embodiments, the network comprises the Internet.

In embodiments, the one or more access permission options comprise a level of mobile device access available to the remote application.

In the description herein, numerous specific details are introduced to provide a thorough understanding of, and enabling description for, embodiments of the systems and methods described herein. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

The systems and methods described herein include and/or run under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, cellular telephones, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components of a host system, and/or provided by some combination of algorithms. The methods described herein can be implemented in one or more of software algorithm(s), programs, firmware, hardware, components, circuitry, in any combination.

System components embodying the systems and methods described herein can be located together or in separate locations. Consequently, system components embodying the systems and methods described herein can be components of a single system, multiple systems, and/or geographically separate systems. These components can also be subcomponents or subsystems of a single system, multiple systems, and/or geographically separate systems. These components can be coupled to one or more other components of a host system or a system coupled to the host system.

Communication paths couple the system components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the systems and methods is not intended to be exhaustive or to limit the systems and methods described to the precise form disclosed. While specific embodiments of, and examples for, the systems and methods are described herein for illustrative purposes, various equivalent modifications are possible within the scope of other systems and methods, as those skilled in the relevant art will recognize. The teachings of the systems and methods provided herein can be applied to other systems and methods, not only for the systems and methods described above.

The elements and acts of the various embodiments described above can be combined to provide further embodiments. These and other changes can be made to the system in light of the above detailed description.

The elements and acts of the various embodiments described above can be combined to provide further embodiments. These and other changes can be made to the embodiments described above in light of the above detailed description.

1. A system comprising,
a remote application running on one or more processors of a remote server;
an operating system application running on at least one processor of a mobile device, the operating system application receiving a notification from the remote application, wherein the notification comprises one or more access permission options for allowing access by the remote application to operations of the mobile device through installation of one or more applications, wherein the operating system application and the remote application are communicatively coupled through a network;
the operating system installing the one or more applications according to a selection of one or more access permission options;
a monitoring application running on a processor of a hardware device, wherein the monitoring application transmits a monitoring signal throughout at least a portion of a premises, wherein the one or more applications, the remote application, and the monitoring application are communicatively coupled through the network;
the one or more applications detecting the monitoring signal;
the one or more applications transmitting a location notification to the remote application through the network in response to the detection of the monitoring signal;
the remote application transmitting one or more instructions to the one or more applications through the network upon receipt of the location notification, wherein the one or more instructions correspond to the one or more access permission options.

2. The system of claim 1, the monitoring application communicatively coupling with one or more additional monitoring applications running on processors of one or more additional hardware devices.

3. The system of claim 2, the one or more additional monitoring applications transmitting the signal through at least an additional portion of the premises.

4. The system of claim 1, wherein monitoring signal comprises an RF signal.

5. The system of claim 4, wherein the strength of the RF signal defines a boundary region.

6. The system of claim 5, wherein the one or more applications detecting the monitoring signal comprises the mobile device entering the boundary region.

7. The system of claim 5, wherein the one or more applications losing the monitoring signal comprises the mobile device exiting the boundary region.

8. The system of claim 1, wherein the one or more instructions comprise instructing the mobile device to enter airplane mode.

9. The system of claim 1, wherein the one or more instructions comprise instructing the mobile device to disable camera operations.

10. The system of claim 1, wherein the one or more instructions comprise instructing the mobile device to disable notifications.

11. The system of claim 1, wherein the one or more instructions comprise instructing the mobile device to power down.

12. The system of claim 1, wherein the network comprises a Local Area Networks (LAN).

13. The system of claim 1, wherein the network comprises a Personal Area Networks (PAN).

14. The system of claim 1, wherein the network comprises a metropolitan area network (MAN).

15. The system of claim 1, wherein the network comprises a wide area network (WAN).

16. The system of claim 1, wherein the network comprises interoffice or backend networks.

17. The system of claim 1, wherein the network comprises cellular networks.

18. The system of claim 1, wherein the network comprises the Internet.

19. The system of claim 1, wherein the one or more access permission options comprise a level of mobile device access available to the remote application.
